(19) United States
(12) Patent Application Publication
(10) Pub. No.: US 2010/0291526 A1
(43) Pub. Date: Nov. 18, 2010

(54) HOUSING WITH CONTAINED THEREIN A STACK OF SHEETS

(76) Inventors: Frank Antonius Wilhelmus Van Duin, Eindhoven (NL); Andrik Dirk Schrijver, Eindhoven (NL)

Correspondence Address: LAW OFFICES OF ERIC KARICH, 2807 ST. MARK DR., MANSFIELD, TX, 76063, US

(21) Appl. No.: 12/670,743

(22) PCT Filed: Jul. 11, 2008
(86) PCT No.: PCT/NL08/50473

§ 371 Date: Jul. 1, 2010

(30) Foreign Application Priority Data
Jul. 26, 2007 (NL) 2000783

(51) Int. Cl. G09B 5/00; H04Q 5/22

(52) U.S. Cl. 434/317; 340/10.1

(57) ABSTRACT

An interactive photo album has an RFID transceiver in one half of a cover. In or on each page of the photo album there is a unique RFID tag. The RFID transceiver can detect the RFID tags in the stack of pages on top of it. A processor on the cover can determine, based on this detection, at what page the album is laid open. The processor plays a sound fragment from a memory on a loudspeaker that corresponds to the page laid open is played back. In addition, a microphone or microphone terminal are provided for recording sound fragments with each page.

### FIELD OF THE INVENTION

The invention relates to a housing with contained therein a stack of sheets which each carry a marker, said housing comprising detection means for detecting the markers, as well as a processor which can determine, based on the detected markers, which sheet is on top of the stack.

### STATE OF THE ART

Radio frequency identification (RFID) (identification with radio waves) is a known technology for remotely reading and storing information of what are called RFID tags attached to or in objects. These tags emit signals by converting the energy of the radio waves. RFID tags can be distinguished from each other by the use of different frequencies. Furthermore, it is possible to store a unique identification number in the tag memory as a result of which the RFID tags can also be distinguished from each other.

A housing with contained therein a stack of sheets is known from U.S. Pat. No. 5,520,544. The housing known from this patent is arranged as a photo album whose cover forms the housing and the pages of the book form the sheets. The sheets are provided with light emitting tracks forming the markers. The cover is provided with a plurality of light sources and light-sensitive cells, each track on each page optically coupling one of the light sources to one of the light-sensitive cells. Any possible combinations of light sources and light-sensitive cells are unique in this context. In the case of bright ambient light there is a chance of disturbances occurring as a result of the fact that the light-sensitive cells take up such an amount of light that the signals originating from the cells correspond to the signals that would be emitted if the light originated from the light sources.

### SUMMARY OF THE INVENTION

The invention is an interactive photo album. The interactive photo album has an RFID transceiver in one half of a cover. In or on each page of the photo album there is a unique RFID tag. The RFID transceiver can detect the RFID tags in the stack of pages on top of it. A processor on the cover can determine, based on this detection, at what page the album is laid open. The processor plays a sound fragment from a memory on a loudspeaker that corresponds to the page laid open is played back.

It is an object of the invention to provide a housing with contains therein a stack of sheets of the type defined in the opening paragraph which is less sensitive to disturbances than the prior art housing with a stack of sheets contained therein. To this end the housing with contained therein a stack of sheets according to the invention is characterized in that each marker comprises an RFID tag and the detection means comprise an RFID transceiver for detection of the RFID tags.

In the housing with contained therein a stack of sheets according to the invention preferably each RFID tag is unique.

In addition, the housing is preferably formed by a cover with one half of the cover accommodating the detection means and the stack of sheets being present on this half when the cover is laid open.

The sheets are preferably formed by pages which are connected to the cover and together with the cover constitute a book, preferably a photo album.

In an advantageous embodiment the housing further includes one or more loudspeakers as well as a voltage source and a memory, the processor playing back a sound fragment stored in the memory, which sound fragment corresponds to the top sheet of the stack of sheets lying on top of this cover half.

In a further advantageous embodiment the housing additionally comprises a microphone or connection means to which a microphone can be connected, which microphone can be instrumental in recording sound fragments which can be stored in the memory by means of the processor.

### BRIEF DESCRIPTION OF THE DRAWING FIGURE

The invention will be further described below in more detail with reference to an embodiment of the housing with contained therein a stack of sheets according to the invention represented in the drawing figure, in which:

FIG. 1 shows an embodiment the housing with contained therein a stack of sheets according to the invention in the form of a photo album.

### DETAILED DESCRIPTION OF THE DRAWING FIGURE

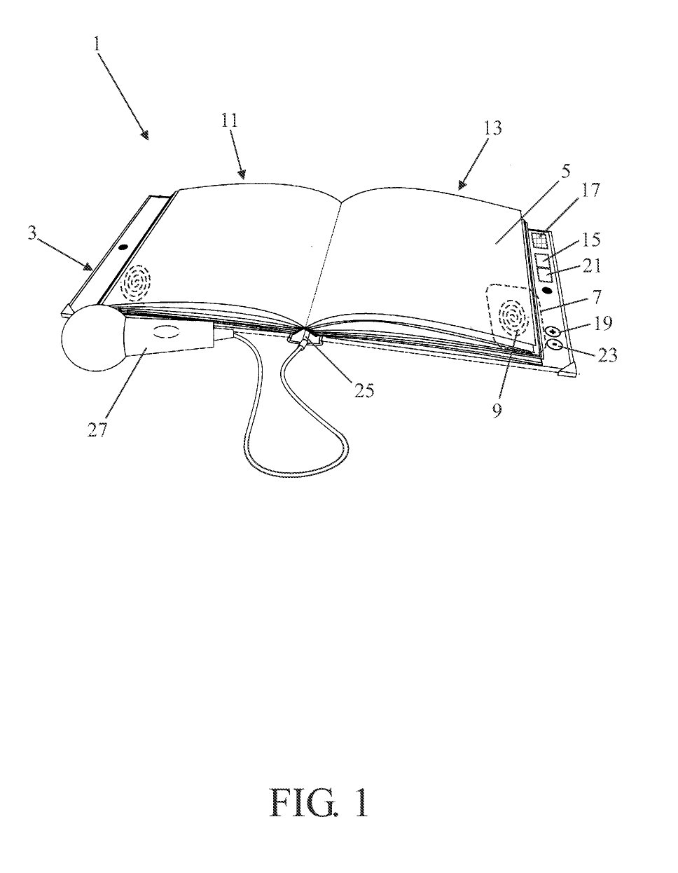

FIG. 1 shows an embodiment of the housing with sheets according to the invention in the form of a photo album 1. The housing is in this case formed by the cover 3 of the photo album and the sheets are formed by the pages 5 of the photo album which are connected to the cover.

One half of the cover accommodates detection means which are formed by an RFID transceiver 7. In or on each page is present a unique RFID tag 9. When the photo album is opened, there is a stack of pages 11, 13 present on either one of the two cover halves. The RFID transceiver 7 can detect the RFID tags 9 in the stack of pages 13 on top of it. A processor 15 (microchip) present in or on the cover can determine, based on this detection, how many and which pages are present on this half of the cover and thus determine thereby at what page the photo album is laid open.

In or on the cover 3 there are furthermore present a loudspeaker 17, a voltage source (battery) 19 and a memory 21. The processor 15 provides that a sound fragment which is stored in the memory 21 and which corresponds to the page laid open is played back. In addition, in or on the cover 3 there is a microphone 23 present which can be used for recording sound fragments with each page, which sound fragments are then stored in the memory 21 by means of the processor 15. The cover 3 also comprises a terminal 25 at which a microphone 27 can be plugged in, so that sound fragments can be recorded with an external microphone as well.

The photo album 1 thus shown is interactive and provides the possibility of recording and playing back sound fragments accompanying the pages. It is possible for each page to be accompanied by an individually selected sound/text by means of the built-in or connectable microphone. The photo album automatically plays back the right fragment with the right page because it comprises page detection.

Albeit the invention has been described in the foregoing with reference to the drawing, it should be pointed out that the invention is not by any manner or means restricted to the embodiment shown in the drawing. The invention also extends over any embodiment deviating from the embodiment shown in the drawing Figure within the spirit and scope defined by the claims. Besides being produced as a photo album, the housing with sheets contained therein could also be produced in other variants such as a book for children to be read to or a language exercise book.

1. A housing with contained therein a stack of sheets which each carry a marker, said housing comprising detection means for detecting the markers, as well as a processor which can determine, based on the detected markers, which sheet is on top of the stack, characterized in that each marker comprises an RFID tag and the detection means comprise an RFID transceiver for detection of the RFID tags.

2. The housing of claim 1, wherein each RFID tag is unique.

3. The housing of claim 1, wherein the housing is formed by a cover with one half of the cover accommodating the detection means and the stack of sheets being present on this half when the cover is laid open.

4. The housing of claim 3, wherein the sheets are formed by pages which are connected to the cover and together with the cover constitute a book.

5. The housing of claim 4, wherein the book is a photo album.

6. The housing of claim 1, wherein the housing further includes one or more loudspeakers as well as a voltage source and a memory, the processor playing back a sound fragment stored in the memory, which sound fragment corresponds to the top sheet of the stack of sheets lying on top of this cover half.

7. The housing of claim 6, wherein the housing additionally comprises a microphone or connection means to which a microphone can be connected, which microphone can be instrumental in recording sound fragments which can be stored in the memory by means of the processor.

8. An interactive photo album comprising:
a stack of sheets which each carry a unique RFID marker;
a cover for containing the stack of sheets in the form of a book;
an RFID transceiver mounted in or on the cover for detecting the location of the RFID markers;
a processor which can determine, based on the detected RFID markers, which sheet is on top of the stack;

9. The interactive photo album of claim 8, wherein the book is a photo album.

10. An interactive photo album comprising:
a stack of sheets which each carry a unique RFID marker;
a cover for containing the stack of sheets in the form of a book;
an RFID transceiver mounted in or on the cover for detecting the location of the RFID markers;
a processor which can determine, based on the detected RFID markers, which sheet is on top of the stack;
a loudspeaker and a memory operably connected to a voltage source, operably mounted in or on the cover, the processor functioning to play back a sound fragment stored in the memory on the loudspeaker, which sound fragment corresponds to the top sheet of the stack of sheets lying on the cover.

11. The interactive photo album of claim 10, wherein the housing additionally comprises a microphone or connection means to which a microphone can be connected, which microphone can be instrumental in recording sound fragments which can be stored in the memory via the processor.
